(19) United States
(12) Patent Application Publication
(10) Pub. No.: US 2024/0161012 A1
(43) Pub. Date: May 16, 2024

(54) FINE-TUNING OF MACHINE LEARNING MODELS ACROSS MULTIPLE NETWORK DEVICES

(71) Applicant: QUALCOMM Incorporated, San Diego, CA (US)

(72) Inventors: Hamed PEZESHKI, San Diego, CA (US); Taesang YOO, San Diego, CA (US); Jay Kumar SUNDARARAJAN, San Diego, CA (US)

(21) Appl. No.: 18/457,116

(22) Filed: Aug. 28, 2023

Related U.S. Application Data
(60) Provisional application No. 63/422,976, filed on Nov. 5, 2022.

(51) Int. Cl. G06N 20/00

(52) U.S. Cl. CPC G06N 20/00

(57) ABSTRACT

An apparatus, method and computer-readable media are disclosed for performing wireless communications. For example, a first network device can transmit, to one or more second network devices, configuration information associated with a trained machine learning model. The first network device can receive, from the one or more second network devices, information associated with a first fine-tuned machine learning model based on adaptation of parameters of the trained machine learning model. The first network device can further output, for transmission to one or more third network devices, configuration information associated with the first fine-tuned machine learning model.

### CROSS-REFERENCE TO RELATED APPLICATIONS

This application is a continuation of U.S. Non-Provisional Application No. 63/422,976, filed Nov. 5, 2022, which is hereby incorporated by reference, in its entirety and for all purposes.

### FIELD

The present disclosure generally relates to machine learning (ML) systems for wireless communications. For example, aspects of the present disclosure relate to systems and techniques for fine-tuning machine learning models across multiple network devices (e.g., multiple user equipment (UEs)).

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML-based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some cases, one or more network devices (e.g., a UE, a base station such as a base station) in a wireless communications system can use trained machine learning (ML) models to implement one or more functions. An ML model at a network device (e.g., a UE) may be trained and/or fine-tuned using online or offline training. For offline training, data collection and training occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

When offline training is performed to fine-tune an ML model, the fine-tuned ML model can be easily deployed across a plurality of UEs. However, when online training is used to fine-tune a UE-side ML model for a single UE, there is no mechanism to allow the fine-tuned ML model to be re-used (and/or further fine-tuned) by other UEs. Solutions are needed for providing an ML model that is trained or fine-tuned using online training for a particular network device (e.g., UE) to other network devices so that the other network devices can use the trained or fine-tuned ML model.

Systems and techniques are described herein for fine-tuning (e.g., using online training) ML models across multiple network devices (e.g., multiple UEs). For example, according to some aspects, a first UE can fine-tune a UE-side ML model (e.g., using online training) that has been previously trained and provided to the first UE. The trained ML model can be fine-tuned directly on the UE or can be fine-tuned by a server device (e.g., a server hosted by a UE vendor of the UE). The UE can then provide the fine-tuned ML model to a network entity. The network entity can share the fine-tuned or updated ML model with other UEs, such as UEs that are similar to the UE (e.g., UEs that have similar hardware components, similar functionality etc. as that of the UE). The other UEs can use the fine-tuned ML model during inference to perform one or more functions.

In some aspects, the fine-tuning of an ML model may be performed sequentially by multiple network devices (e.g., by a single UE at each fine-tuning stage or round). In some cases, the fine-tuning can be performed for a group of UEs at each fine-tuning stage or round (e.g., using federated learning techniques). In some aspects, the network entity can configure a UE (or a group of UEs) with a deadline for each fine-tuning stage or round.

In one illustrative example, a method of wireless communication at a first network entity is provided. The method can include: transmitting, to one or more second network devices, configuration information associated with a trained machine learning model; receiving, from the one or more second network devices, information associated with a first fine-tuned machine learning model based on adaptation of parameters of the trained machine learning model; and transmitting, to one or more third network devices, configuration information associated with the first fine-tuned machine learning model.

In another example, a first network entity is provided. The first network entity can include at least one memory and at least one processor (e.g., configured in circuitry) coupled to the at least one memory and configured to: output, for transmission to one or more second network devices, configuration information associated with a trained machine learning model; receive, from the one or more second network devices, information associated with a first fine-tuned machine learning model based on adaptation of parameters of the trained machine learning model; and output, for transmission to one or more third network devices, configuration information associated with the first fine-tuned machine learning model.

In another example, a non-transitory computer-readable storage medium of a first network entity is provided that includes instructions stored thereon which, when executed by at least one processor, causes the at least one processor to: output, for transmission to one or more second network devices, configuration information associated with a trained machine learning model; receive, from the one or more second network devices, information associated with a first fine-tuned machine learning model based on adaptation of parameters of the trained machine learning model; and output, for transmission to one or more third network devices, configuration information associated with the first fine-tuned machine learning model.

In another example, a first network entity for wireless communications is provided that includes: means for transmitting, to one or more second network devices, configuration information associated with a trained machine learning model; means for receiving, from the one or more second network devices, information associated with a first fine-tuned machine learning model based on adaptation of parameters of the trained machine learning model; and means for transmitting, to one or more third network devices, configuration information associated with the first fine-tuned machine learning model.

In another example, a method of wireless communications at a first network device is provided. The method includes: transmitting, to a second network device, capability information associated with capability of the first network device to fine-tune one or more trained machine learning models; receiving, from the second network device based on the capability information, configuration information associated with a trained machine learning model; and transmitting, to the second network device, information associated with a fine-tuned machine learning model based on adaptation of parameters of the trained machine learning model.

In another example, a first network device for wireless communications is provided. The first network device includes at least one memory and at least one processor coupled to the at least one memory and configured to: output, for transmission to a second network device, capability information associated with capability of the first network device to fine-tune one or more trained machine learning models; receive, from the second network device based on the capability information, configuration information associated with a trained machine learning model; and output, for transmission to the second network device, information associated with a fine-tuned machine learning model based on adaptation of parameters of the trained machine learning model.

In another example, a non-transitory computer-readable storage medium of a first network entity is provided that includes instructions stored thereon which, when executed by at least one processor, causes the at least one processor to: output, for transmission to a second network device, capability information associated with capability of the first network device to fine-tune one or more trained machine learning models; receive, from the second network device based on the capability information, configuration information associated with a trained machine learning model; and output, for transmission to the second network device, information associated with a fine-tuned machine learning model based on adaptation of parameters of the trained machine learning model.

In another example, a first network entity for wireless communications is provided that includes: means for transmitting, to a second network device, capability information associated with capability of the first network device to fine-tune one or more trained machine learning models; means for receiving, from the second network device based on the capability information, configuration information associated with a trained machine learning model; and means for transmitting, to the second network device, information associated with a fine-tuned machine learning model based on adaptation of parameters of the trained machine learning model.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7 is a signaling diagram illustrating an example of communications between a network entity and user equipment (UEs) for fine-tuning machine learning models across the multiple UEs, in accordance with aspects of the present disclosure;

FIG. 8 is a signaling diagram illustrating an example of communications between a network entity and groups of UEs for fine-tuning machine learning models across the groups of UEs, in accordance with aspects of the present disclosure;

FIG. 9 is a diagram illustrating an example of a system for performing federated learning for updating machine learning models, in accordance with aspects of the present disclosure;

FIG. 10 is a flow diagram illustrating an example of a process for wireless communications, in accordance with aspects of the present disclosure;

FIG. 11 is a flow diagram illustrating another example of a process for wireless communications, in accordance with aspects of the present disclosure; and

FIG. 12 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station), or a component of a disaggregated base station (e.g., a central unit (CU), distributed unit (DU), radio unit (RU), Near-Real Time (Near-RT) radio access network (RAN) Intelligent Controller (RIC), or a Non-Real Time (Non-RT) RIC of a gNB). In one example, an access link between a UE and a 3GPP gNB may be over a Uu interface. In some cases, an access link may support uplink signaling, downlink signaling, connection procedures, etc.

In some cases, using a machine learning (ML)-based air interface, a network device (e.g., a UE) and/or a network entity (e.g., a base station such as a gNB) may use trained ML models to implement one or more functions. For example, a UE can monitor a channel to determine information indicating a quality or state of the channel, which can be referred to as channel state information (CSI) or channel state feedback (CSF). To convey the CSI or CSF to a base station (e.g., a gNB or a portion of the gNB, such as a CU, DU, RU, Near-RT RIC, or a Non-RT RIC of the gNB), the UE can use a neural network (e.g., an encoder neural network model) to derive a compressed representation (also referred to as a latent representation) of the CSI/CSF for transmission to the base station. The base station may use another neural network (e.g., a decoder neural network model) to reconstruct the target CSI from the compressed representation. Network devices (e.g., UEs, gNB s, etc.) can additionally or alternatively use ML models for other functions, such as to select a radio frequency (RF) beam for communications, to predict a discontinuous reception (DRX) schedule for a UE, etc.

Two example procedures that can be used for training ML models include offline training and online training. For offline training, data collection and training occur in an offline manner at the network side (e.g., at a gNB or other network entity) or at the UE side (e.g., the data collection and training may be transparent to the network). The offline training may not involve 3GPP signaling. UE-side training can refer to local UE training (e.g., training on the UE itself) and can also refer to training of a UE-side ML model at a server device (e.g., a server hosted by a UE vendor). For the server-based offline training, the UE may send data (e.g., reference signal measurements, etc.) to the server device, which may be used by the server device for training the UE-side ML model. For online training, 3GPP signaling may be used (e.g., signaling transmitted from a gNB to a UE) and the training of a UE-side ML model may be performed in a real-time or near-real-time manner locally at the UE or by a server device (e.g., a server hosted by a UE vendor) based on data provided to the server device from the UE. These offline and online training procedures can also apply to fine-tuning of ML models (e.g., fine-tuning parameters of a previously-trained ML model).

A working assumption from 3GPP RANI 110 is that online training is an artificial intelligence/machine learning (AI/ML) training process where the model being used for inference is (e.g., continuously) trained in real-time (or near real-time) as new training samples are received. The notion of (near) real-time versus non real-time is context-dependent and is relative to the inference time-scale. The RAN definition for online training only serves as a guidance. There may be cases that may not exactly conform to this definition but may still be categorized as online training by commonly accepted conventions. Further, fine-tuning/re-training may be performed via online or offline training. Another working assumption from 3GPP RANI 110 is that offline training is an AI/ML training process where the model is trained based on collected dataset, and where the trained model is later used or delivered for inference. The definition for offline training only serves as a guidance. There may be cases that may not exactly conform to this definition for offline training but may still be categorized as offline training by commonly accepted conventions.

Various approaches can be used to achieve good performance of ML models across different scenarios, configurations, sites, etc. for a communications system. For example, one approach is model generalization, which refers to using one ML model that is generalizable to different scenarios, configurations, sites, etc. Another approach is ML model switching. ML model switching includes switching among a group of ML models (e.g., two or more models), where each model can be trained for a particular scenario, configuration, site, etc. In some cases, models in a group of ML models may have varying model structures or architectures, may share a common model structure/architecture, or may partially share a common sub-structure or sub-architecture. In some examples, models in a group of ML models may have different input/output formats and/or different pre-/post-processing components. Another approach is providing a model update (e.g., via fine-tuning). For example, a network device (e.g., a UE) can use one model with parameters that are flexibly updated (e.g., via fine-tuning using the offline or online training techniques described above) as the scenario, configuration, site, etc. that the network device experiences changes over time.

As noted above, an ML model at a network device (e.g., a UE) may be trained and/or fine-tuned using online or offline training. If offline training is performed to fine-tune an ML model, the fine-tuned ML model can be easily deployed across a plurality of network devices (e.g., UEs). However, a disadvantage of using online training to fine-tune a UE-side ML model for a single UE is the lack of usability of the updated ML model by other UEs. For instance, once a UE updates an ML model using online-based fine-tuning, there is no mechanism by which the fine-tuned ML model can be re-used (or further fine-tuned) by other UEs. Solutions are needed for providing an ML model that is trained or fine-tuned using online training for a particular network device (e.g., UE) to other network devices (e.g., other UEs that are similar to the particular UE, such as UEs having similar hardware capabilities as the particular UE) so that the other network devices can use the trained or fine-tuned ML model.

Systems, apparatuses, processes (also referred to as methods), and computer-readable media (collectively referred to herein as “systems and techniques”) are described herein for fine-tuning (e.g., using online training) machine learning models across multiple network devices (e.g., multiple UEs). Using such systems and techniques, ML models fine-tuned for a network device (e.g., a UE) can be reused across a larger number of network devices (e.g., UEs). A UE will be used herein as an example of a network device upon which an ML model can be fine-tuned. However, the systems and techniques described herein can be used for fine-tuning ML models using other types of network devices.

In some aspects, a first UE can fine-tune a UE-side ML model (e.g., a neural network based model or other ML model) that has been previously trained. For example, before being deployed at the UE side, the ML model can be trained via offline training by another network device or network entity (e.g., a base station, such as a gNB, or a portion of the base station, such as a CU, DU, RU, etc. of the base station). Configuration information associated with the trained ML model can be transmitted (e.g., by the other network device or entity) to the first UE. In some cases, the first UE can transmit capability information to the other network device or entity. The capability information can include the UE's capability for fine-tuning the UE-side ML model (e.g., the UE's capability in performing finetuning of trained ML models, an approximate time it takes for the UE to fine-tune trained ML models, such as in terms of model complexity, model type, etc.). In such cases, the other network device or entity can transmit the configuration information to the first UE based on and/or in response to the received capability information. For instance, a network entity (e.g., the base station or portion thereof) can transmit to the first UE architecture information defining or indicating an architecture (e.g., a neural network architecture, such as one or more specific neural network layers) to be used for the trained ML model, one or more parameters of the trained ML model (e.g., weights, biases, and/or other parameters of the trained ML model), one or more loss functions for use in fine-tuning the trained ML model, any combination thereof, and/or other information associated with the trained ML model. The first UE can use the trained ML model during inference to perform one or more functions, such as to compress CSI or CSF, to determine a DRX schedule, and/or other function. The first UE can also use locally observed data (e.g., measurements of reference signals from a gNB, measured channel conditions, etc.) to fine-tune parameters of the trained ML model using online training. The parameters of the trained ML model that can be fine-tuned or updated include weights, biases, and/or other parameters. The trained ML model can be fine-tuned directly on the UE or can be fine-tuned by a server device (e.g., a server hosted by a UE vendor of the UE).

Once the trained model has been fine-tuned, the UE can provide (e.g., transmit, upload, etc.) information associated with the fine-tuned (or updated) ML model to a network entity, such as by providing architecture information defining or indicating an architecture to be used for the fine-tuned ML model, one or more parameters (e.g., weights, biases, etc.) of the fine-tuned ML model, and/or other information associated with the fine-tuned ML model. The network entity can be the same network entity (e.g., the base station, such as a gNB, or a portion of the base station, such as a CU, DU, RU, et.) that provided the trained ML model, another base station, a server device (e.g., a server hosted by the UE, a server hosted by a chipset vendor of a chipset of the UE), or other network entity.

The network entity can share (e.g., transmit, provide on a server for download, etc.) configuration information associated with the fine-tuned or updated ML model with other UEs, such as UEs that are similar to the UE. For instance, the network entity can share with the other UEs the architecture information, the parameter(s), and/or other information associated with the fine-tuned ML model. As used herein, a UE that is “similar” to another UE can include a UE that has similar hardware components (e.g., a modem, an RF front-end, power amplifiers (PAs), processors such as neural processing units (NPUs), digital signal processors (DSPs) etc., or other hardware), similar functionality (e.g., multiple-input-multiple output (MIMO) functionality, etc.), or other component or functionality that can affect the performance of an ML model. In some cases, UEs that are similar may be grouped into tiers or quality levels. In such cases, the network entity can transmit a fine-tuned ML model that is fine-tuned by a UE of a particular tier to other UEs of the same tier. The other UEs can obtain (e.g., receive, download, etc.) the fine-tuned or updated ML model and use the fine-tuned ML model during inference to perform one or more functions (e.g., compress CSI or CSF, determine a DRX schedule, and/or other function).

In some aspects, the fine-tuning of an ML model may be performed in a sequential manner by multiple network devices (e.g., UEs). For instance, a second UE can receive (e.g., from the network entity) the fine-tuned ML model updated at the first UE and can perform the fine-tuning process (e.g., locally at the second UE or using a server device) to generate a further fine-tuned ML model. In some cases, the second UE can also use the fine-tuned ML model (or the further fine-tuned ML model) for inference to perform one or more functions. The second UE can provide (e.g., transmit, upload, etc.) information associated with the further fine-tuned (or updated) ML model to the network entity (e.g., architecture information, the parameter(s), and/or other information associated with the further fine-tuned ML model). The further fine-tuned ML model can then be obtained (e.g., received from the network entity, downloaded, etc.) by a third UE that can use the further fine-tuned ML model for inference. The process can be repeated across any number of UEs.

In some cases, the above-described fine-tuning process may be performed for fine-tuning an ML model at a single UE for each fine-tuning stage or round. In other cases, the fine-tuning can be performed for a group of UEs at each fine-tuning stage or round (e.g., using federated learning techniques). For instance, a first group of UEs can perform collective fine-tuning of a UE-side ML model (e.g., using federated learning) along with a network entity (e.g., a base station or portion thereof, a network server, etc.). The network entity or other entity can share (e.g., transmit, provide on a server for download, etc.) the fine-tuned or updated ML model with a second group of UEs. In some cases, the second group of UEs can perform an additional fine-tuning of the ML model fine-tuned by the first group of UEs. The process can be repeated across any number of groups of UEs.

In some aspects, the network entity can configure a UE (or a group of UEs) with a deadline for each fine-tuning stage or round, such as by transmitting signaling (e.g., via radio resource control (RRC) signaling, physical downlink control channel (PDCCH) signaling, physical downlink shared channel (PDSCH) signaling, or other signaling) with an indication of the deadline to the UE or group of UEs. For instance, the deadline may indicate to the UE(s) a time or duration by which the UE(s) will have to provide (e.g., transmit, upload, etc.) the fine-tuned or updated ML model to the network entity or other entity.

Additional aspects of the present disclosure are described in more detail below.

As used herein, the terms “user equipment” (UE), “network device,” “network entity,” and like terms are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity (which can also be referred to as a network device) may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

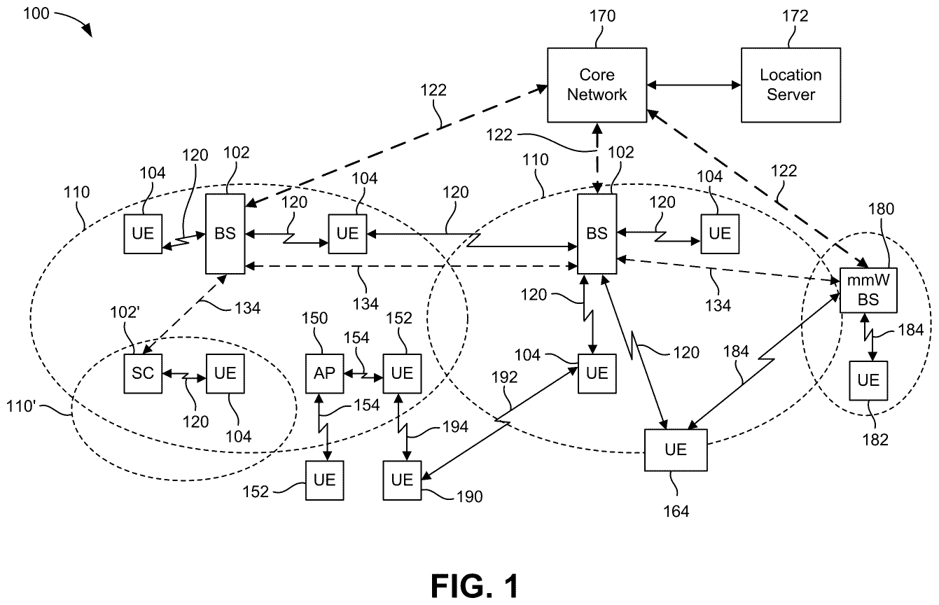

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

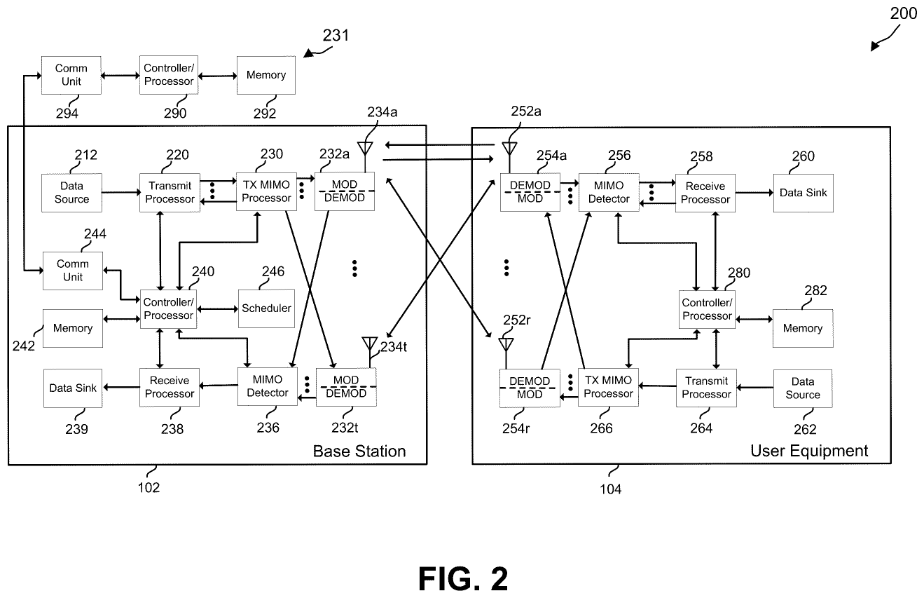

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

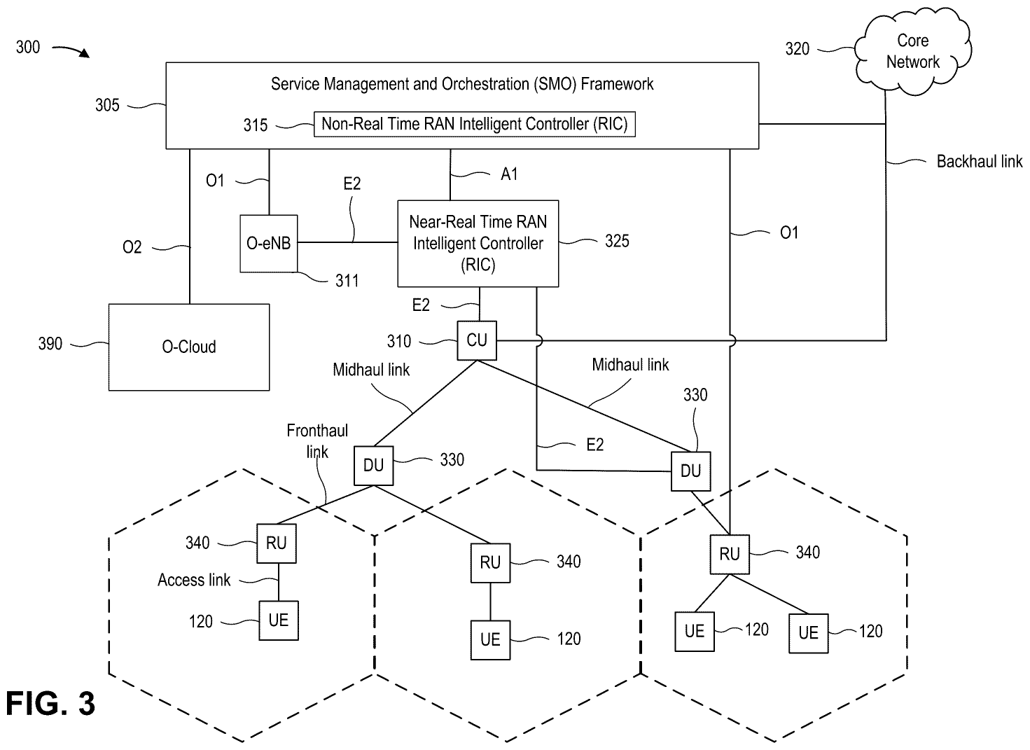

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

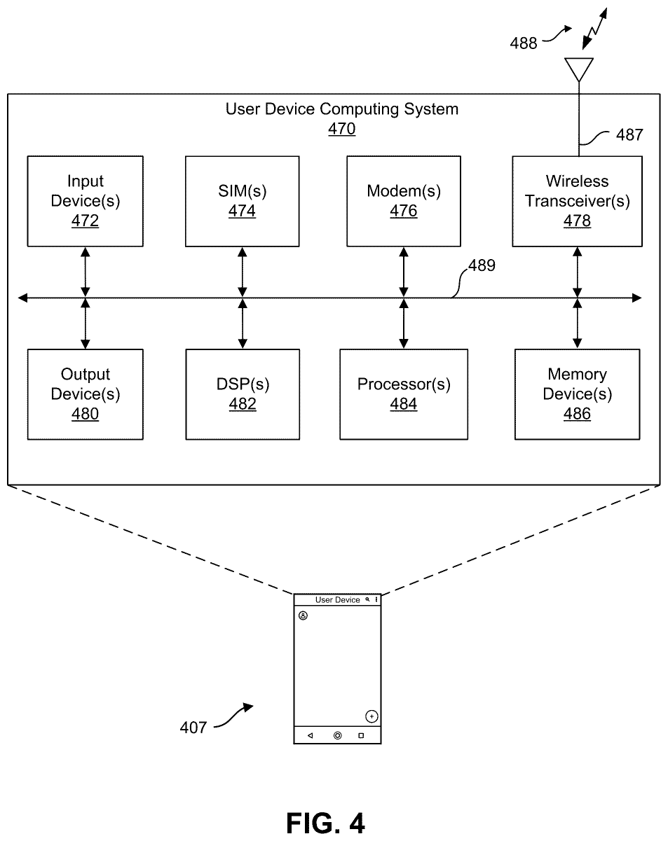

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

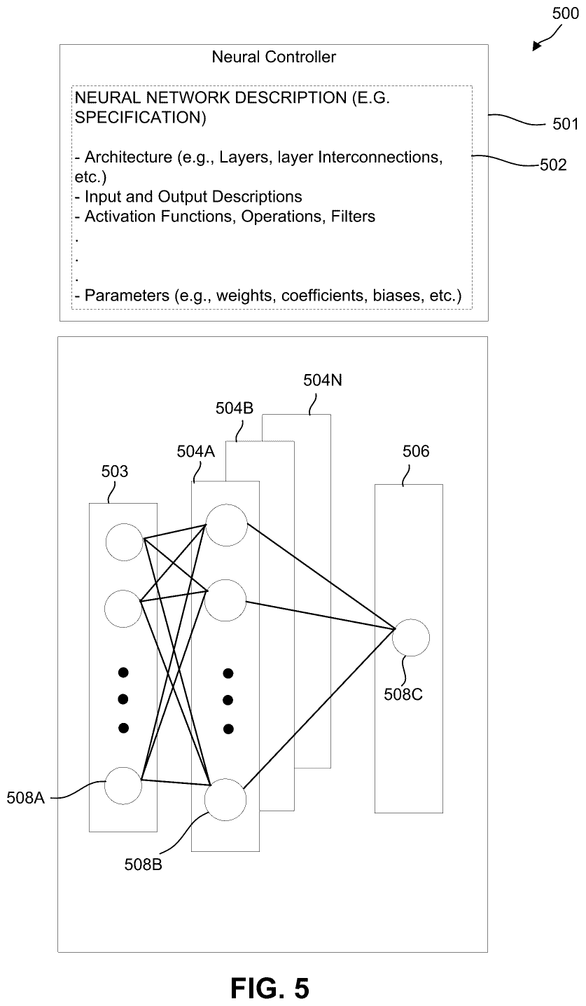

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (which may be referred to collectively as “504”). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

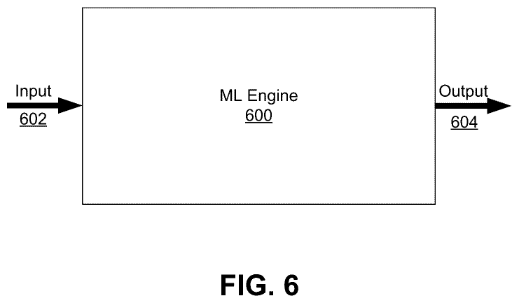

Increasingly AI-ML algorithms or models are being incorporated into a variety of technologies and are being incorporated into wireless telecommunications standards. FIG. 6 is a block diagram illustrating an ML engine 600. As an example, one or more devices in a wireless system may include the ML engine 600. In some cases, ML engine 600 may be similar to (e.g., have a similar architecture and functionality) neural network 500. In the example of FIG. 6, ML engine 600 includes three parts, input 602 to the ML engine 600, the ML engine 600 itself, and the output 604 from the ML engine 600. The input 602 to the ML engine 600 may be data from which the ML engine 600 can use to make predictions or otherwise operate on. As an example, an ML engine 600 configured to select an RF beam for transmitting or receiving communications signals may take, as input 602, data regarding current RF conditions, location information, network load, etc. As another example, data related to packets sent to a UE, along with historical packet data may be input 602 to an ML engine 600 configured to predict a discontinuous reception (DRX) schedule for the UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

In another example, the ML engine 600 may be an encoder used to compress control information (e.g., channel state information (CSI) or channel state feedback (CSF)) determined by a UE in order to generate a representation (e.g., a latent representation) of the control information. In another example, the ML engine 600 may be an encoder used by a network entity (e.g., a base station) to decode a representation (e.g., a latent representation) of the control information (e.g., CSI) generated by a UE.

As previously noted, ML models may be trained or fine-tuned using offline training and/or online training. In performing offline training or fine-tuning, data collection and training occur in an offline manner at the network side (e.g., at a gNB or other network entity) or at the UE side (e.g., the data collection and training may be transparent to the network). 3GPP signaling is not needed for offline training or fine-tuning. UE-side training or fine-tuning can refer to local UE training or fine-tuning (e.g., training on the UE itself) and can also refer to training or fine-tuning of a UE-side ML model at a server device, which may be a server hosted by a UE vendor or other server device. For offline training or fine-tuning using a server device, the UE can send data (e.g., reference signal measurements, etc.) to the server device. The server device can use the data to train or fine-tune the UE-side ML model.

For online training or fine-tuning, 3GPP signaling may be used, such as signaling transmitted from a gNB to a UE. The online training or fine-tuning of a UE-side ML model may be performed in a real-time or near-real-time manner locally at the UE or by a server device (e.g., a server hosted by a UE vendor) based on data provided to the server device from the UE.

While an ML model fine-tuned using offline training can be easily provided to multiple other network devices (e.g., UEs), an ML model of a network device (e.g., a UE-side ML model for a single UE) that is fine-tuned using online training lacks usability by other UEs. For example, when a UE updates an ML model using online-based fine-tuning (e.g., directly on the UE or via a server device), there is currently no procedure in place to allow the fine-tuned ML model to be deployed to and re-used (e.g., for inference or for further fine-tuning) by other UEs.

The systems and techniques described herein allow for fine-tuning (e.g., using online training) of machine learning models across multiple network devices (e.g., multiple UEs). For example, an ML model fine-tuned for a network device (e.g., a UE) can be reused across multiple other network devices (e.g., UEs). In some cases, the fine-tuning may be performed for fine-tuning an ML model at a single UE for each fine-tuning stage or round. In other cases, the fine-tuning can be performed for a group of UEs at each fine-tuning stage or round (e.g., using federated learning techniques).

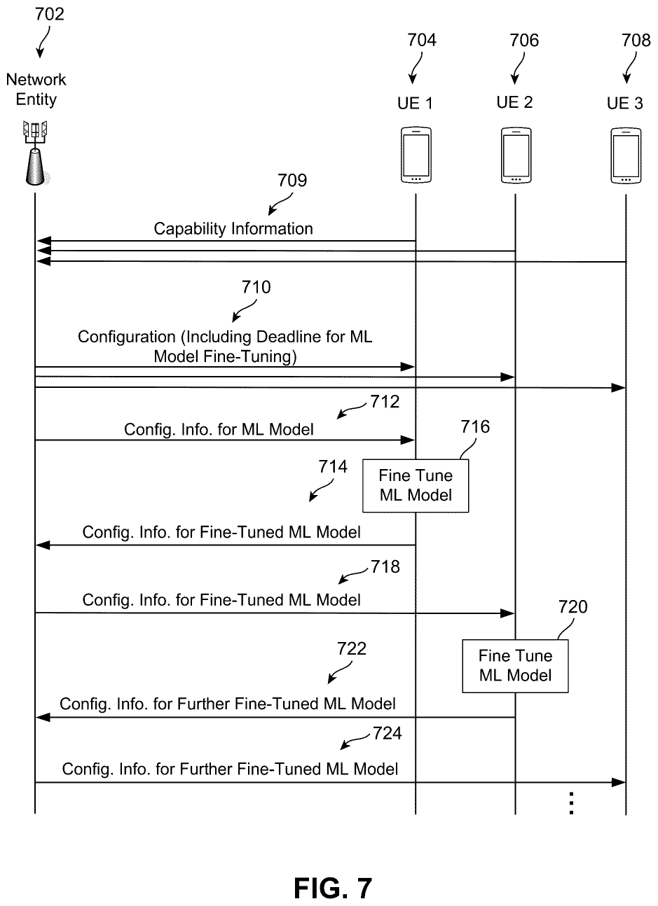

FIG. 7 is a signaling diagram illustrating an example of communications between a network entity 702 and various UEs (including a first UE 704, a second UE 706, and a third UE 708) for fine-tuning machine learning models across the multiple UEs. The network entity 702 can be a base station (e.g., the base station 102 of FIG. 1, the base station 102 of FIG. 2, the disaggregated base station 300 of FIG. 3, or other base station), part of the base station (e.g., the CU 310, the DU 330, the RU 340, the Near-RT RIC 325, and/or the Non-RT RIC 315 of the disaggregated base station 300 of FIG. 3), a server device, or another network device or entity.

The network entity 702 can train an ML model using offline training. The trained ML model can be provided to the first UE 704, the second UE 706, and the third UE 708. For instance, the network entity 702 or other entity can transmit the ML model to the first UE 704, the second UE 706, and the third UE 708, the first UE 704, the second UE 706, and the third UE 708 can obtain (e.g., download or otherwise obtain) the ML model from a server system, or the like. In one illustrative example, the ML model can be or can be part of the ML engine 600 of FIG. 6. In some cases, the network entity 702 can train the ML model using offline training using data from a data collection procedure (e.g., according to the 3GPP Radio Access Network 4 (RAN4) data collection). For example, the network entity 702 can collect data from participating vendors or companies based on agreed test configurations.

In some cases, the first UE 704, the second UE 706, and the third UE 708 can transmit capability information 709 to the network entity 702. The capability information 709 can include a respective capability for each of the first UE 704, the second UE 706, and the third UE 708 to fine-tune UE-side ML models, including the ML model trained by the network entity 702. For instance, capability information 709 can include a capability of a UE (e.g., the first UE 704, the second UE 706, and/or the third UE 708) in performing finetuning of trained ML models. In some cases, the capability information 709 can additionally include an approximate time it takes for the UE to fine-tune trained ML models, such as in terms of model complexity, model type, etc.

The network entity 702 can transmit configuration information 710 to the first UE 704, the second UE 706, and the third UE 708. In some cases, the network entity 702 can transmit the configuration information 710 based on the received capability information 709 (e.g., in response to receiving the capability information 709). In some aspects, the configuration information 710 can be determined based on the capability information 709 received from each of the first UE 704, the second UE 706, and the third UE 708. In some cases, the configuration information 710 can include deadline information indicating a deadline for adapting the parameters of the trained ML model. For example, the deadline can indicate to the UEs 704, 706, 708 a time or duration by which the UEs will have to provide (e.g., transmit, upload, etc.) the fine-tuned or updated ML model to the network entity 702 or another entity (e.g., a server from which the network entity 702 can download the fine-tuned ML model or configuration information defining an architecture and/or parameters of the fine-tuned ML model). The deadline can be set for each fine-tuning stage or round (e.g., each time a UE 704, 706, or 708 performs the fine-tuning described below). In some aspects, the configuration information 710 can be transmitted via radio resource control (RRC) signaling, physical downlink control channel (PDCCH) signaling, physical downlink shared channel (PDSCH) signaling, or other signaling.

The network entity 702 can also provide the trained ML model to the first UE 704. For instance, the network entity 702 can transmit configuration information 712 associated with the ML model to the first UE 704 or can provide the configuration information 712 to a server for download by the first UE 704. In one illustrative example, the configuration information 712 can include architecture information defining or indicating an architecture (e.g., a neural network architecture, such as one or more specific neural network layers) to be used for the trained ML model, one or more parameters of the trained ML model (e.g., weights, biases, and/or other parameters of the trained ML model), one or more loss functions for use in fine-tuning the trained ML model, and/or other information associated with the trained ML model.

The first UE 704 can use the trained ML model during inference to perform one or more functions. As described herein, the ML model can be used to perform functions such compressing CSI or CSF, determining a DRX schedule, selecting or determining a beam to use for reception or transmission of communications signals, and/or other function(s). At block 716, the first UE 704 can fine-tune or update the parameters (e.g., weights, biases, and/or other parameters) of the trained ML model by performing online training using locally observed data. The locally observed data can include reference signals, channel conditions, or other data. For instance, the first UE 704 can receive reference signals from the network entity 702 or other network entity or device and can measure a strength or quality (e.g., RSRP, RSSI, RSRQ, CQI, etc.) of the reference signals. The trained ML model can be fine-tuned directly on the UE 704 or can be fine-tuned by a server device (e.g., a server hosted by a UE vendor of the first UE 704) that is in communication with the first UE 704. For example, for the server-based training, the first UE 704 can transmit the locally observed data to the server device. The server device can perform the online training to update or fine-tune the parameters of the ML model. The server device can then transmit configuration information (e.g., architecture information, one or more parameters, etc.) for the fine-tuned model to the first UE 704.

Once the trained model has been fine-tuned at block 716, the first UE 704 can provide (e.g., transmit, upload, etc.) the fine-tuned ML model to the network entity 702. For instance, the first UE 704 can transmit configuration information 714 associated with the fine-tuned ML model to the network entity 702 or can upload the configuration information 712 to a server for download by the network entity 702. The configuration information 714 can include architecture information defining or indicating an architecture to be used for the fine-tuned ML model, one or more parameters (e.g., weights, biases, etc.) of the fine-tuned ML model, and/or other information associated with the fine-tuned ML model. The network entity 702 can share (e.g., transmit, provide on a server for download, etc.) the fine-tuned ML model with other UEs, such as the second UE 706 and/or the third UE 708. For instance, the network entity 702 can share with the other UEs the architecture information, the parameter(s), the loss function information, and/or other information associated with the fine-tuned ML model.

In some cases, the network entity 702 can share the fine-tuned ML model with other UEs (e.g., the second UE 706 and/or the third UE 708) that are similar to the first UE 704 in a way that can affect the performance of an ML model. For example, the other UEs can have similar hardware components as that of the first UE 704, such as a similar modem, a similar RF front-end, one or more similar power amplifiers (PAs), one or more similar processors (e.g., neural processing units (NPUs), digital signal processors (DSPs), graphics processing units (GPUs), etc.), and/or other hardware. Additionally or alternatively, the other UEs may have similar functionality, such as similar multiple-input-multiple output (MIMO) functionality or other functionality. In some aspects, UEs that are similar may be grouped into tiers or quality levels. In such aspects, the network entity 702 can transmit a fine-tuned ML model that is fine-tuned by the first UE 704, which may of a particular tier, to other UEs of the same tier (e.g., the second UE 706 and the third UE 708). The other UEs can obtain (e.g., receive, download, etc.) the fine-tuned or updated ML model and use the fine-tuned ML model during inference to perform one or more functions (e.g., compress CSI or CSF, determine a DRX schedule, and/or other function).

The fine-tuning of the ML model may be performed in a sequential manner the first UE 704, the second UE 706, and the third UE 708, which may be of similar tiers or quality levels in some cases. For instance, after the first UE 704 provides the fine-tuned ML model to the network entity 702 (e.g., by providing the configuration information 714), the network entity 702 can provide the fine-tuned ML model to the second UE 706. In one example, the network entity 702 can transmit configuration information 718 (e.g., architecture information, parameter(s), loss function information, etc.) associated with the fine-tuned ML model to the second UE 706 or can upload the configuration information 718 to a server for download by the second UE 706. In some cases, the configuration information 718 can be the same as the configuration information 714. At block 720, the second UE 706 can perform the fine-tuning process (e.g., locally at the second UE 706 or using a server device) to generate a further fine-tuned ML model. The second UE 706 can also use the fine-tuned ML model (or the further fine-tuned ML model) for inference to perform one or more functions. The second UE 706 can provide (e.g., transmit, upload, etc.) the further fine-tuned (or updated) ML model to the network entity 702. For example, the second UE 706 can transmit configuration information 722 (e.g., architecture information, parameter(s), loss function information, etc.) associated with the further fine-tuned ML model to the network entity 702 or can upload the configuration information 722 to a server for download by the network entity 702.

The network entity 702 can then provide the further fine-tuned ML model to the third UE 708, such as by transmitting configuration information 724 (e.g., architecture information, parameter(s), loss function information, etc.) associated with the fine-tuned ML model to the second UE 706 or can upload the configuration information 724 to a server for download by the second UE 706. In some cases, the configuration information 724 can be the same as the configuration information 722. The sequential fine-tuning process can be repeated across any number of UEs.

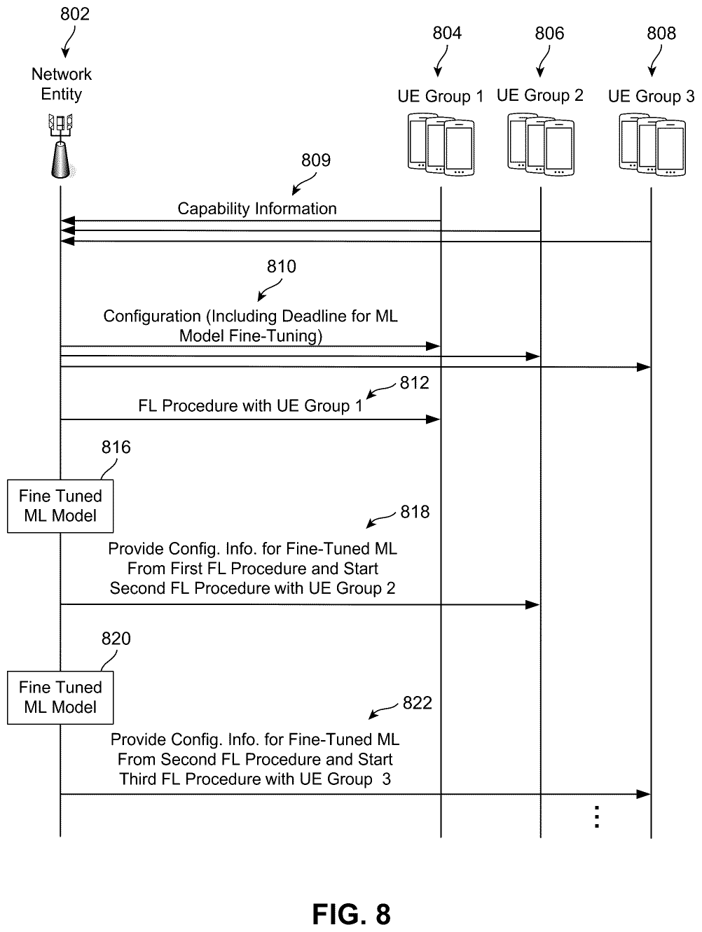

As described above, the fine-tuning can be performed for a group of UEs at each fine-tuning stage or round (e.g., using federated learning techniques). FIG. 8 is a signaling diagram illustrating an example of communications between a network entity 802 and groups of UEs (including a first group 804 of UEs, a second group 806 of UEs, and a third group 808 of UEs) for fine-tuning machine learning models across the groups of UEs. The network entity 802 can be a base station (e.g., the base station 102 of FIG. 1, the base station 102 of FIG. 2, the disaggregated base station 300 of FIG. 3, or other base station), part of the base station (e.g., the CU 310, the DU 330, the RU 340, the Near-RT RIC 325, and/or the Non-RT RIC 315 of the disaggregated base station 300 of FIG. 3), a server device, or another network device or entity.

Similar to that described with respect to FIG. 7, the network entity 802 can train an ML model using offline training. The trained ML model can be provided to the first UE 804, the second UE 806, and the third UE 808 (e.g., the network entity 802 or other entity can transmit the ML model to the first UE 804, the second UE 806, and the third UE 808, the first UE 804, the second UE 806, and the third UE 808 can obtain the ML model from a server system, etc.). In one illustrative example, the ML model can be or can be part of the ML engine 600 of FIG. 6. In some cases, the network entity 802 can train the ML model using offline training using data from a data collection procedure (e.g., according to the 3GPP Radio Access Network 4 (RAN4) data collection).

In some aspects, the first UE 804, the second UE 806, and the third UE 808 can transmit capability information 809 to the network entity 802. The capability information 809 can include a respective capability for each of the first UE 804, the second UE 806, and the third UE 808 to fine-tune UE-side ML models, including the ML model trained by the network entity 802. The capability information 809 can be similar to the capability information 709 described with respect to FIG. 7.

The network entity 802 can transmit the configuration information 810 to the first group 804 of UEs, the second group 806 of UEs, and the third group 808 of UEs. In some cases, the network entity 802 can transmit the configuration information 810 based on the received capability information 809 (e.g., in response to receiving the capability information 809). In some aspects, the configuration information 810 can be determined based on the capability information 809 received from each of the first UE 804, the second UE 806, and the third UE 808. In some cases, the configuration information 810 can include deadline information indicating the deadline for adapting the parameters of the trained machine learning mode. For example, the deadline can indicate to each group 804, 806, 808 the UEs a time or duration by which the respective groups of UEs will have to provide (e.g., transmit, upload, etc.) the fine-tuned or updated ML model to the network entity 802 or another entity. The deadline can be set for each fine-tuning stage or round (e.g., each time a UE group 804, 806, or 808 performs the fine-tuning described below). In some aspects, the configuration information 810 can be transmitted via RRC signaling, PDCCH signaling, PDSCH signaling, or other signaling.

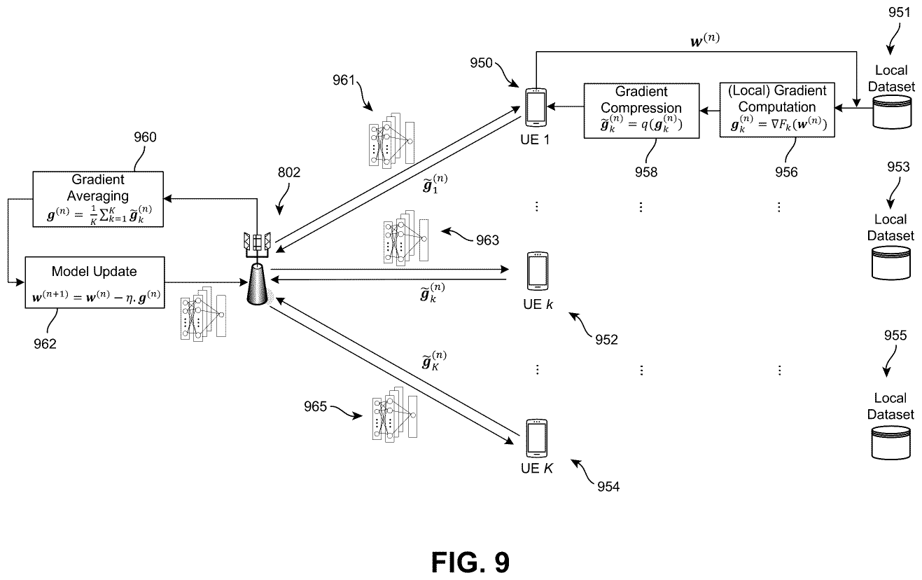

The network entity 802 can begin a federated learning (FL) procedure with the first group 804 of UEs to generate a fine-tuned ML model 816. FIG. 9 is a diagram illustrating an example of a system for performing federated learning (FL) for updating machine learning models. The system includes the network entity 802 and a group of UEs (e.g., corresponding to the first group 804 of UEs of FIG. 8), including UE 1 950, UE k 952, through UE K 954. Each of the UE 1 950, UE k 952, through UE K 954 includes a respective local dataset 951, 953, 955. For example, using the dataset 951, the UE 1 950 performs a local gradient computation using a gradient computation engine 956 to determine gradients that can be used in a gradient descent process to fine-tune the trained ML model. In one illustrative example, the gradients can be computed based on the following:

gₖ⁽ⁿ⁾=∇Fₖ(w⁽ⁿ⁾) Equation (1)

The UE 1 950 can then perform gradient compression using a gradient compression engine 958 to compress the gradients into compressed gradients. In one illustrative example, the gradients can be compressed based on the following:

\tilde{g}ₖ⁽ⁿ⁾=q(gₖ⁽ⁿ⁾) Equation (2)

The UE 1 950 can transmit the compressed gradients (e.g., the compressed gradients \tilde{g}ₖ⁽ⁿ⁾ to the network entity 802. The UE k 952 through the UE K 954 can also determine gradients, compress the gradients, and transmit the compressed gradients to the network entity 802. The network entity 802 can average the compressed gradients (or the gradients after decompression of the compressed gradients) from the UE 1 950, the UE k 952, through the UE K 954 using a gradient averaging engine 960. In one illustrative example, the gradients can be averaged based on the following:

$${g}^{( n )} = \frac{1}{K} {\sum }_{k = 1}^{K} {\tilde{g}}_{k}^{( n )} \qquad Equation ( 3 )$$

The network entity 802 can then update the ML model based on the gradients using a model update engine 962. For instance, the model update engine 962 can perform gradient descent-based backpropagation using the gradients to update or tune the parameters (e.g., weights, biases, etc.) the ML model. In one illustrative example, the ML model can be updated based on the following:

w⁽ⁿ⁺¹⁾=w⁽ⁿ⁾−η·g⁽ⁿ⁾ Equation (4)

The network entity 802 can transmit configuration information (e.g., configuration information 961, configuration information 963, through configuration information 965) associated with the updated ML model back to the UE 1 950, which can continue the process to compute gradients, compress the gradients, etc. As described herein, the configuration information can include architecture information, parameter(s), loss function information, any combination thereof, and/or other information associated with the updated ML model. The FL process can be performed until a loss value is below a minimum loss value, after which the trained ML model is considered fine-tuned (or updated) and ready to be used for inference.

Returning to FIG. 8, the network entity 802 can transmit configuration information 818 (e.g., architecture information, parameter(s), loss function information, etc.) associated with the fine-tuned ML model 816 to the second group 806 of UEs or can upload the configuration information 818 to a server for download by the second group 806 of UEs. The network entity 802 can perform the FL procedure with the second group 806 of UEs to generate a further fine-tuned ML model 820, using a similar procedure as that described above with respect to FIG. 9 for the first group 804 of UEs. The network entity 802 can then transmit configuration information 822 (e.g., architecture information, parameter(s), loss function information, etc.) associated with the further fine-tuned ML model 820 to the third group 808 of UEs or can upload the configuration information 822 to a server for download by the third group 808 of UEs. The FL-based fine-tuning process can be repeated across any number of groups of UEs.

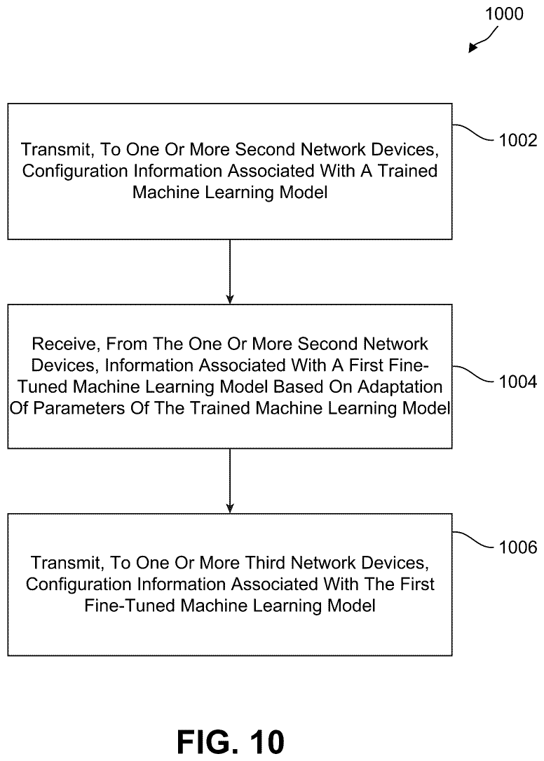

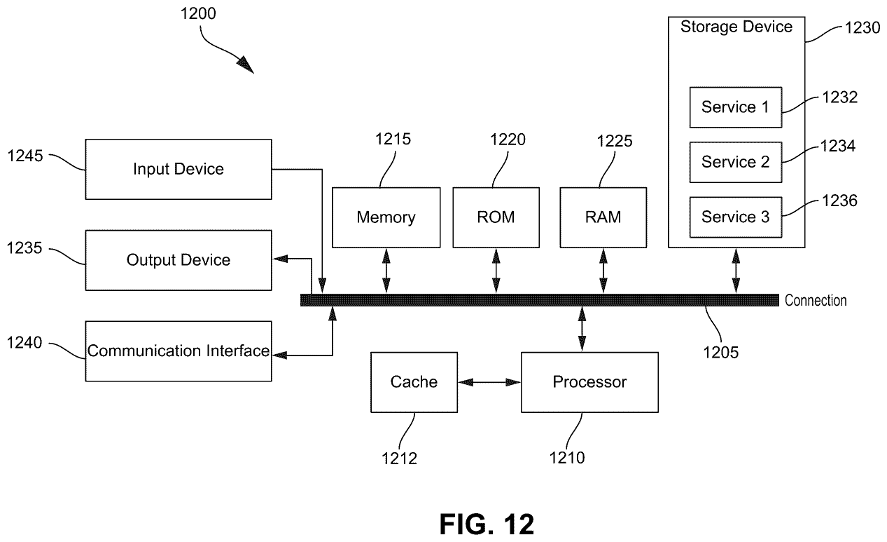

FIG. 10 is a flow diagram illustrating a process 1000 for performing wireless communications. The process 1000 can be performed by a first network device or network entity or by a component or system (e.g., a chipset) of the first network device or entity. The first network device or entity can be a base station (e.g., the base station 102 of FIG. 1, the base station 102 of FIG. 2, the disaggregated base station 300 of FIG. 3, or other base station), part of the base station (e.g., the CU 310, the DU 330, the RU 340, the Near-RT RIC 325, and/or the Non-RT RIC 315 of the disaggregated base station 300 of FIG. 3), or another network device or entity. The operations of the process 1000 may be implemented as software components that are executed and run on one or more processors (e.g., one or more of the processors of the base station 102 of FIG. 2, the processor 1210 of FIG. 12, and/or other processor(s)). Further, the transmission and reception of signals by the first network device or entity in the process 1000 may be enabled, for example, by one or more antennas and/or one or more transceivers such as wireless transceiver(s) (e.g., one or more of the communication components of the base station 102 of FIG. 2, the communication interface 1240 of FIG. 12, and/or other antennas and/or transceivers).

At block 1002, the first network device (or component thereof) can transmit (e.g., using one or more of the communication components of the base station 102 of FIG. 2, such as the transmit processor 220, the TX MIMO processor 230, the modulator 232a, and/or the antenna 234a of FIG. 2), to one or more second network devices, configuration information associated with a trained machine learning model. For instance, the configuration information associated with the trained machine learning model can include architecture information for the trained machine learning model and one or more parameters of the trained machine learning model.

At block 1004, the first network device (or component thereof) can receive (e.g., using one or more of the communication components of the base station 102 of FIG. 2, such as the receive processor 238, the MIMO detector 236, the demodulator 232t, and/or the antenna 234t of FIG. 2), from the one or more second network devices, information associated with a first fine-tuned machine learning model based on adaptation of parameters of the trained machine learning model. For instance, the configuration information associated with the first fine-tuned machine learning model can include architecture information for the first fine-tuned machine learning model and one or more parameters of the first fine-tuned machine learning model.

At block 1006, the first network device (or component thereof) can transmit (e.g., using one or more of the communication components of the base station 102 of FIG. 2, such as the transmit processor 220, the TX MIMO processor 230, the modulator 232a, and/or the antenna 234a of FIG. 2), to one or more third network devices, configuration information associated with the first fine-tuned machine learning model. In some aspects, the first network device (or component thereof) can receive capability information (e.g., capability information 709, capability information 809, etc.) from the one or more second network devices. The capability information is associated with capability of the one or more second network devices to fine-tuning one or more trained machine learning models (e.g., a capability of a UE in performing finetuning of trained ML models, an approximate time it takes for the UE to fine-tune trained ML models, such as in terms of model complexity, model type, etc.). The first network device (or component thereof) can transmit the configuration information based on the received capability information. In some aspects, the first network device (or component thereof) can receive, from the one or more third network devices, information associated with a second fine-tuned machine learning model based on adaptation of parameters of the first fine-tuned machine learning model. In some aspects, the first network device (or component thereof) can transmit, to one or more fourth network devices, configuration information associated with the second fine-tuned machine learning model.

In some aspects, the one or more second network devices include(s) a single network device (e.g., the first UE 704 of FIG. 7). In such cases, the information associated with the first fine-tuned machine learning model received from the one or more second network devices is the configuration information associated with the first fine-tuned machine learning model. In such cases, the configuration information associated with the first fine-tuned machine learning model can include architecture information for the first fine-tuned machine learning model and one or more parameters of the first fine-tuned machine learning model.

In other aspects, the one or more second network devices include(s) a plurality of network devices (e.g., the first group 804 of UEs of FIG. 8). In such aspects, the information associated with the first fine-tuned machine learning model received from the one or more second network devices includes training data. For instance, the training data can include gradient data (e.g., the gradients described with respect to FIG. 9). The gradient data can include at least first gradient data from a first of the plurality of network devices (e.g., the UE 1 950) and second gradient data from a second of the plurality of network devices (e.g., the UE k 952). In such aspects, the first network device (or component thereof) can update the trained machine learning model based on the training data (e.g., the gradient data) to generate the first fine-tuned machine learning model, such as using the federated learning procedure described above with respect to FIG. 9.

In some aspects, the first network device (or component thereof) can transmit, to the one or more second network devices, deadline information indicating a deadline for adapting the parameters of the trained machine learning model.

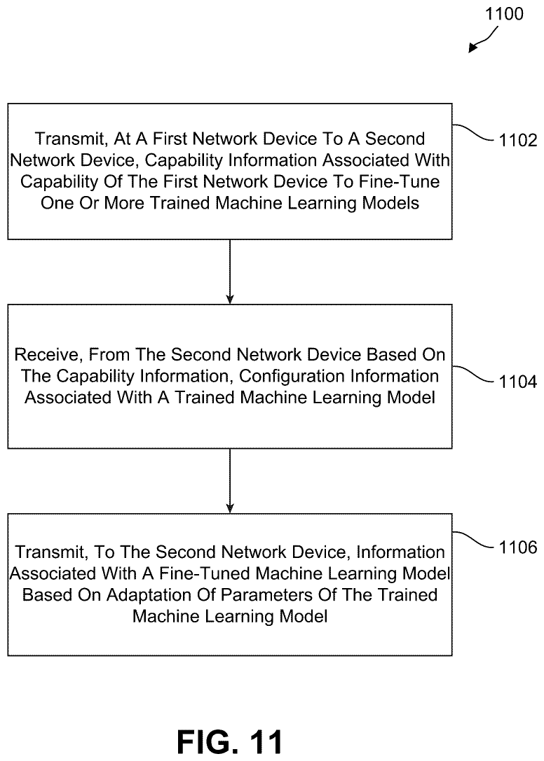

FIG. 11 is a flow diagram illustrating a process 1100 for performing wireless communications. The process 1100 can be performed by a first network device or by a component or system (e.g., a chipset) of the first network device. The first network device can be a UE (e.g., the UE 704 of FIG. 7, the UE 706 of FIG. 7, the UE 708 of FIG. 7, a UE from the first group 804 of UEs of FIG. 8, a UE from the second group 806 of UEs of FIG. 8, a UE from the third group 808 of UEs of FIG. 8, or other UE). In some cases, the UE can be a wireless communication device (e.g., a mobile phone, router, tablet computer, laptop computer, and/or tracking device, etc.), a wearable device (e.g., smartwatch, smart-glasses, wearable ring, and/or an extended reality (XR) device such as a virtual reality (VR) headset, an augmented reality (AR) headset or glasses, or a mixed reality (MR) headset), a vehicle (e.g., automobile, motorcycle, bicycle, etc.) or a computing device, component, or system of the vehicle, an Internet of Things (IoT) device, etc., used by a user to communicate over a wireless communications network. The operations of the process 1100 may be implemented as software components that are executed and run on one or more processors (e.g., one or more of the processors of the UE 104 of FIG. 2, the processor 484 of FIG. 4, the processor 1210 of FIG. 12, or other processor(s)). Further, the transmission and reception of signals by the first network device in the process 1100 may be enabled, for example, by one or more antennas and/or one or more transceivers such as wireless transceiver(s) (e.g., one or more of the communication components of the UE 104 of FIG. 2, wireless transceiver(s) 478 of FIG. 4, the communication interface 1240 of FIG. 12, and/or other antennas and/or transceivers).

At block 1102, the first network device (or component thereof) can transmit (e.g., using one or more of the communication components of the UE 104 of FIG. 2, such as the transmit processor 264, the TX MIMO processor 266, the modulator 254r, and/or the antenna 252r of FIG. 2, the one or more wireless transceivers 478 of FIG. 4, etc.), to a second network device, capability information associated with capability of the first network device to fine-tune one or more trained machine learning models. The second network device can be a base station (e.g., the base station 102 of FIG. 1, the base station 102 of FIG. 2, the disaggregated base station 300 of FIG. 3, or other base station), part of the base station (e.g., the CU 310, the DU 330, the RU 340, the Near-RT RIC 325, and/or the Non-RT RIC 315 of the disaggregated base station 300 of FIG. 3), or another network device or entity.

At block 1104, the first network device (or component thereof) can receive (e.g., using one or more of the communication components of the base station 102 of FIG. 2, such as the receive processor 258, the MIMO detector 256, the demodulator 254a, and/or the antenna 252a of FIG. 2, the one or more wireless transceivers 478 of FIG. 4, etc.), from the second network device based on the capability information, configuration information associated with a trained machine learning model. In some cases, as described herein, the configuration information associated with the trained machine learning model can include architecture information for the trained machine learning model and one or more parameters of the trained machine learning model.

At block 1106, the first network device (or component thereof) can transmit (e.g., using one or more of the communication components of the UE 104 of FIG. 2, such as the transmit processor 264, the TX MIMO processor 266, the modulator 254r, and/or the antenna 252r of FIG. 2, the one or more wireless transceivers 478 of FIG. 4, etc.), to the second network device, information associated with a fine-tuned machine learning model based on adaptation of parameters of the trained machine learning model. In some cases, the information associated with the fine-tuned machine learning model comprises architecture information for the fine-tuned machine learning model and one or more parameters of the fine-tuned machine learning model.

In some aspects, the first network device (or component thereof) can receive, from the second network device, deadline information indicating a deadline for adapting the parameters of the trained machine learning model.

The network devices described above with respect to FIG. 10 and FIG. 11 may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the network device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000 and the process 1100 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000, the process 1100, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some embodiments, computing system 1200 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some embodiments, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A method of wireless communications at a first network device, the method comprising: transmitting, to one or more second network devices, configuration information associated with a trained machine learning model; receiving, from the one or more second network devices, information associated with a first fine-tuned machine learning model based on adaptation of parameters of the trained machine learning model; and transmitting, to one or more third network devices, configuration information associated with the first fine-tuned machine learning model.
Aspect 2. The method of Aspect 1, further comprising: receiving, from the one or more third network devices, information associated with a second fine-tuned machine learning model based on adaptation of parameters of the first fine-tuned machine learning model.
Aspect 3. The method of Aspect 2, further comprising: transmitting, to one or more fourth network devices, configuration information associated with the second fine-tuned machine learning model.
Aspect 4. The method of any one of Aspects 1 to 3, wherein the configuration information associated with the trained machine learning model includes architecture information for the trained machine learning model and one or more parameters of the trained machine learning model.
Aspect 5. The method of any one of Aspects 1 to 4, wherein the configuration information associated with the first fine-tuned machine learning model includes architecture information for the first fine-tuned machine learning model and one or more parameters of the first fine-tuned machine learning model.
Aspect 6. The method of any one of Aspects 1 to 5, wherein the one or more second network devices includes a single network device.
Aspect 7. The method of Aspect 6, wherein the information associated with the first fine-tuned machine learning model received from the one or more second network devices is the configuration information associated with the first fine-tuned machine learning model, and wherein the configuration information associated with the first fine-tuned machine learning model comprises architecture information for the first fine-tuned machine learning model and one or more parameters of the first fine-tuned machine learning model.
Aspect 8. The method of any one of Aspects 1 to 5, wherein the one or more second network devices includes a plurality of network devices.
Aspect 9. The method of Aspect 8, wherein the information associated with the first fine-tuned machine learning model received from the one or more second network devices comprises training data, and wherein the method further comprises: updating the trained machine learning model based on the training data to generate the first fine-tuned machine learning model.
Aspect 10. The method of Aspect 9, wherein the training data comprises gradient data.
Aspect 11. The method of Aspect 10, wherein the gradient data comprises at least first gradient data from a first of the plurality of network devices and second gradient data from a second of the plurality of network devices.
Aspect 12. The method of any one of Aspects 1 to 11, further comprising: transmitting, to the one or more second network devices, deadline information indicating a deadline for adapting the parameters of the trained machine learning model.
Aspect 13. The method of any one of Aspects 1 to 12, further comprising: receiving capability information from the one or more second network devices, the capability information being associated with capability of the one or more second network devices to fine-tuning one or more trained machine learning models; and transmitting the configuration information based on the received capability information.
Aspect 14. A first network device for wireless communications, the first network device comprising: at least one memory; and at least one processor coupled to the at least one memory and configured to: output, for transmission to one or more second network devices, configuration information associated with a trained machine learning model; receive, from the one or more second network devices, information associated with a first fine-tuned machine learning model based on adaptation of parameters of the trained machine learning model; and output, for transmission to one or more third network devices, configuration information associated with the first fine-tuned machine learning model.
Aspect 15. The first network device of Aspect 14, wherein the at least one processor is configured to: receive, from the one or more third network devices, information associated with a second fine-tuned machine learning model based on adaptation of parameters of the first fine-tuned machine learning model.
Aspect 16. The first network device of Aspect 15, wherein the at least one processor is configured to: output, for transmission to one or more fourth network devices, configuration information associated with the second fine-tuned machine learning model.
Aspect 17. The first network device of any one of Aspects 14 to 16, wherein the configuration information associated with the trained machine learning model includes architecture information for the trained machine learning model and one or more parameters of the trained machine learning model.
Aspect 18. The first network device of any one of Aspects 14 to 17, wherein the configuration information associated with the first fine-tuned machine learning model includes architecture information for the first fine-tuned machine learning model and one or more parameters of the first fine-tuned machine learning model.
Aspect 19. The first network device of any one of Aspects 14 to 18, wherein the one or more second network devices includes a single network device.
Aspect 20. The first network device of Aspect 19, wherein the information associated with the first fine-tuned machine learning model received from the one or more second network devices is the configuration information associated with the first fine-tuned machine learning model, and wherein the configuration information associated with the first fine-tuned machine learning model comprises architecture information for the first fine-tuned machine learning model and one or more parameters of the first fine-tuned machine learning model.
Aspect 21. The first network device of any one of Aspects 14 to 18, wherein the one or more second network devices includes a plurality of network devices.
Aspect 22. The first network device of Aspect 21, wherein the information associated with the first fine-tuned machine learning model received from the one or more second network devices comprises training data, and wherein the at least one processor is configured to: update the trained machine learning model based on the training data to generate the first fine-tuned machine learning model.
Aspect 23. The first network device of Aspect 22, wherein the training data comprises gradient data.
Aspect 24. The first network device of Aspect 23, wherein the gradient data comprises at least first gradient data from a first of the plurality of network devices and second gradient data from a second of the plurality of network devices.
Aspect 25. The first network device of any one of Aspects 14 to 24, wherein the at least one processor is configured to: output, for transmission to the one or more second network devices, deadline information indicating a deadline for adapting the parameters of the trained machine learning model.
Aspect 26. The first network device of any one of Aspects 14 to 25, wherein the at least one processor is configured to: receive capability information from the one or more second network devices, the capability information being associated with capability of the one or more second network devices to fine-tuning one or more trained machine learning models; and output the configuration information based on the received capability information.
Aspect 27. A non-transitory computer-readable storage medium comprising instructions stored thereon which, when executed by at least one processor, causes the at least one processor to perform operations according to any of Aspects 1 to 13.
Aspect 28. An apparatus for wireless communications comprising one or more means for performing operations according to any of Aspects 1 to 13.
Aspect 29. A first network device for wireless communications, the first network device comprising: at least one memory; and at least one processor coupled to the at least one memory and configured to: output, for transmission to a second network device, capability information associated with capability of the first network device to fine-tune one or more trained machine learning models; receive, from the second network device based on the capability information, configuration information associated with a trained machine learning model; and output, for transmission to the second network device, information associated with a fine-tuned machine learning model based on adaptation of parameters of the trained machine learning model.
Aspect 30. The first network device of Aspect 29, wherein the at least one processor is configured to: receive, from the second network device, deadline information indicating a deadline for adapting the parameters of the trained machine learning model.
Aspect 31. The first network device of any one of Aspects 29 or 30, wherein the configuration information associated with the trained machine learning model includes architecture information for the trained machine learning model and one or more parameters of the trained machine learning model.
Aspect 32. The first network device of any one of Aspects 29 to 31, wherein the information associated with the fine-tuned machine learning model comprises architecture information for the fine-tuned machine learning model and one or more parameters of the fine-tuned machine learning model.
Aspect 33. A method of wireless communications at a first network device, the method comprising: transmitting, to a second network device, capability information associated with capability of the first network device to fine-tune one or more trained machine learning models; receiving, from the second network device based on the capability information, configuration information associated with a trained machine learning model; and transmitting, to the second network device, information associated with a fine-tuned machine learning model based on adaptation of parameters of the trained machine learning model.
Aspect 34. The method of claim Aspect 33, further comprising: receiving, from the second network device, deadline information indicating a deadline for adapting the parameters of the trained machine learning model.
Aspect 35. The method of any one of Aspects 33 or 34, wherein the configuration information associated with the trained machine learning model includes architecture information for the trained machine learning model and one or more parameters of the trained machine learning model.
Aspect 36. The method of any one of Aspects 33 to 35, wherein the information associated with the fine-tuned machine learning model comprises architecture information for the fine-tuned machine learning model and one or more parameters of the fine-tuned machine learning model.
Aspect 37. A non-transitory computer-readable storage medium comprising instructions stored thereon which, when executed by at least one processor, causes the at least one processor to perform operations according to any of Aspects 33 to 36.
Aspect 38. An apparatus for wireless communications comprising one or more means for performing operations according to any of Aspects 33 to 36.

What is claimed is:

1. A first network device for wireless communications, the first network device comprising:
at least one memory; and
at least one processor coupled to the at least one memory and configured to:
output, for transmission to one or more second network devices, configuration information associated with a trained machine learning model;
receive, from the one or more second network devices, information associated with a first fine-tuned machine learning model based on adaptation of parameters of the trained machine learning model; and
output, for transmission to one or more third network devices, configuration information associated with the first fine-tuned machine learning model.

2. The first network device of claim 1, wherein the at least one processor is configured to:
receive, from the one or more third network devices, information associated with a second fine-tuned machine learning model based on adaptation of parameters of the first fine-tuned machine learning model.

3. The first network device of claim 2, wherein the at least one processor is configured to:
output, for transmission to one or more fourth network devices, configuration information associated with the second fine-tuned machine learning model.

4. The first network device of claim 1, wherein the configuration information associated with the trained machine learning model includes architecture information for the trained machine learning model and one or more parameters of the trained machine learning model.

5. The first network device of claim 1, wherein the configuration information associated with the first fine-tuned machine learning model includes architecture information for the first fine-tuned machine learning model and one or more parameters of the first fine-tuned machine learning model.

6. The first network device of claim 1, wherein the one or more second network devices includes a single network device.

7. The first network device of claim 6, wherein the information associated with the first fine-tuned machine learning model received from the one or more second network devices is the configuration information associated with the first fine-tuned machine learning model, and wherein the configuration information associated with the first fine-tuned machine learning model comprises architecture information for the first fine-tuned machine learning model and one or more parameters of the first fine-tuned machine learning model.

8. The first network device of claim 1, wherein the one or more second network devices includes a plurality of network devices.

9. The first network device of claim 8, wherein the information associated with the first fine-tuned machine learning model received from the one or more second network devices comprises training data, and wherein the at least one processor is configured to:
update the trained machine learning model based on the training data to generate the first fine-tuned machine learning model.

10. The first network device of claim 9, wherein the training data comprises gradient data.

11. The first network device of claim 10, wherein the gradient data comprises at least first gradient data from a first of the plurality of network devices and second gradient data from a second of the plurality of network devices.

12. The first network device of claim 1, wherein the at least one processor is configured to:
output, for transmission to the one or more second network devices, deadline information indicating a deadline for adapting the parameters of the trained machine learning model.

13. The first network device of claim 1, wherein the at least one processor is configured to:
receive capability information from the one or more second network devices, the capability information being associated with capability of the one or more second network devices to fine-tuning one or more trained machine learning models; and
output the configuration information based on the received capability information.

14. A method of wireless communications at a first network device, the method comprising:
transmitting, to one or more second network devices, configuration information associated with a trained machine learning model;
receiving, from the one or more second network devices, information associated with a first fine-tuned machine learning model based on adaptation of parameters of the trained machine learning model; and
transmitting, to one or more third network devices, configuration information associated with the first fine-tuned machine learning model.

15. The method of claim 14, further comprising:
receiving, from the one or more third network devices, information associated with a second fine-tuned machine learning model based on adaptation of parameters of the first fine-tuned machine learning model.

16. The method of claim 15, further comprising:
transmitting, to one or more fourth network devices, configuration information associated with the second fine-tuned machine learning model.

17. The method of claim 14, wherein the configuration information associated with the trained machine learning model includes architecture information for the trained machine learning model and one or more parameters of the trained machine learning model.

18. The method of claim 14, wherein the configuration information associated with the first fine-tuned machine learning model includes architecture information for the first fine-tuned machine learning model and one or more parameters of the first fine-tuned machine learning model.

19. The method of claim 14, wherein the one or more second network devices includes a single network device.

20. The method of claim 19, wherein the information associated with the first fine-tuned machine learning model received from the one or more second network devices is the configuration information associated with the first fine-tuned machine learning model, and wherein the configuration information associated with the first fine-tuned machine learning model comprises architecture information for the first fine-tuned machine learning model and one or more parameters of the first fine-tuned machine learning model.

21. The method of claim 14, wherein the one or more second network devices includes a plurality of network devices.

22. The method of claim 21, wherein the information associated with the first fine-tuned machine learning model received from the one or more second network devices comprises training data, and wherein the method further comprises:
updating the trained machine learning model based on the training data to generate the first fine-tuned machine learning model.

23. The method of claim 22, wherein the training data comprises gradient data.

24. The method of claim 23, wherein the gradient data comprises at least first gradient data from a first of the plurality of network devices and second gradient data from a second of the plurality of network devices.

25. The method of claim 14, further comprising:
transmitting, to the one or more second network devices, deadline information indicating a deadline for adapting the parameters of the trained machine learning model.

26. The method of claim 14, further comprising:
receiving capability information from the one or more second network devices, the capability information being associated with capability of the one or more second network devices to fine-tuning one or more trained machine learning models; and
transmitting the configuration information based on the received capability information.

27. A first network device for wireless communications, the first network device comprising:
at least one memory; and
at least one processor coupled to the at least one memory and configured to:
output, for transmission to a second network device, capability information associated with capability of the first network device to fine-tune one or more trained machine learning models;
receive, from the second network device based on the capability information, configuration information associated with a trained machine learning model; and
output, for transmission to the second network device, information associated with a fine-tuned machine learning model based on adaptation of parameters of the trained machine learning model.

28. The first network device of claim 27, wherein the at least one processor is configured to:
receive, from the second network device, deadline information indicating a deadline for adapting the parameters of the trained machine learning model.

29. A method of wireless communications at a first network device, the method comprising:
transmitting, to a second network device, capability information associated with capability of the first network device to fine-tune one or more trained machine learning models;
receiving, from the second network device based on the capability information, configuration information associated with a trained machine learning model; and
transmitting, to the second network device, information associated with a fine-tuned machine learning model based on adaptation of parameters of the trained machine learning model.

30. The method of claim 29, further comprising:
receiving, from the second network device, deadline information indicating a deadline for adapting the parameters of the trained machine learning model.
